(19) United States
(12) Patent Application Publication
(10) Pub. No.: US 2014/0252127 A1
(43) Pub. Date: Sep. 11, 2014

(54) Multi-color spraying device

(71) Applicant: Gennadi Fedorov, Blairstown, NJ (US)

(72) Inventor: Gennadi Fedorov, Blairstown, NJ (US)

(21) Appl. No.: 13/786,437

(22) Filed: Mar. 5, 2013

(51) Int. Cl. B05B 11/00

(52) U.S. Cl. CPC B05B 11/0054
USPC 239/305

(57) ABSTRACT

A spraying device with multi-color cartridge, having an array of liquid tanks, arranged around horizontal axel of cartridge rotation.

And

A spraying device with multi-color cartridge, having an array of liquid tanks, arranged around vertical axel of cartridge rotation.

### CROSS-REFERENCE TO RELATED APPLICATIONS

Not Applicable

STATEMENT REGARDING FEDERALLY SPONSORED RESEARCH OR DEVELOPMENT

Not Applicable

REFERENCE TO SEQUENCE LISTING, A TABLE, OR A COMPUTER PROGRAM LISTING COMPACT DISK APPENDIX

Not Applicable

### FIELD OF INVENTION

The invention disclosed here relates in general to a field of spraying devices using liquid and pressurized air, and more particularly, to method and system for quick and easy change between sprayed colors or multiple liquid substances.

### BACKGROUND OF THE INVENTION

The present invention is in the technical field of hand-held spraying devices. More particularly, the present invention is in the technical field of spraying liquids, such as paints, liquid cosmetic solutions, liquid medications or coatings which enter into chemical reaction when sprayed as multiple layers on top of each other.

Conventional spraying devices, such as hand-held airbrushes all require either to drain one color or liquid from the feeding tank before filling tank with a different color or liquid. A clear cleanser must often be sprayed through the device inbetween color change to clean the nozzle and avoid cross-contamination. Many current spraying devices require to detach used tank from the handle and attach another one. Process of switching from one color or liquid type to another often requires spraying of new liquid content into an absorbing tissue or collecting container to purge remnants of previously used color/liquid and avoid cross-contaminated spray between first and second color/liquid.

Spraying devices, such as airbrush or spray gun can be of two systems: internal mixture and external mixture. Internal mixture devices mix compressed air and sprayed liquid inside the nozzle or inside a channel in close proximity to the front nozzle of airbrush. External mixture devices mix compressed air and liquid outside the nozzle of a gun or airbrush and nozzle of liquid tank. In both case working principle of these devices is based on Venturi effect.

### SUMMARY OF THE INVENTION

The present invention is a hand-held spraying device that allows its users to instantly switch between multiple colors or liquid types without any cross contamination of colors or liquid types and without need to ever drain and clean airbrush before, during or after use of airbrush.

A hand-held spraying device is described that includes a handle which has ergonomically curved rear portion and straight front portion, trigger which controls pressurized air and which is located generally in a middle section of the handle, main air nozzle located at the front end of the handle, air inlet tube located on the lower side of the handle generally in its middle, multi-color cartridge which attaches to the handle. Multi-color cartridge includes a mainframe , an array of liquid tanks which may contain liquid paints or any liquid for spraying, a front sealing ring.

Multi-color cartridge has an axel of rotation, around which array of liquid tanks can be rotated and each of the liquid tanks can be easily positioned in front of a main air nozzle for spraying ink, color, paint or other liquid contained in this liquid tank.

In one embodiment multi-color cartridge holds liquid tanks horizontally and has horizontally positioned axel of rotation of liquid tanks array. Sealing ring of the cartridge is positioned vertically.

In another embodiment multi-color cartridge holds liquid tanks vertically and provides vertical axel of rotation of liquid tanks and sealing ring is positioned horizontally.

### BRIEF DESCRIPTION OF THE DRAWINGS

FIG. 1 is a side view of a spraying device of the first embodiment of present invention;

FIG. 2 is a forward perspective view of a spraying device of FIG. 1, in accordance with first embodiment of present invention;

FIG. 3 is a rear perspective view of a spraying device of FIG. 1, in accordance with first embodiment of present invention;

FIG. 4 is an exploded view of a spraying device of FIG. 1, in accordance with first embodiment of present invention;

FIG. 5 is a side view of a spraying device of second embodiment of present invention;

FIG. 6 is a forward perspective view of a spraying device of FIG. 5, in accordance with second embodiment of present invention;

FIG. 7 is backward perspective view of spraying device of FIG. 5, in accordance with second embodiment of present invention;

FIG. 8 is an exploded view of spraying device of FIG. 5, in accordance with second embodiment of present invention;

FIG. 9 is an exploded view of multi-color cartridge of spraying device of FIG. 5, in accordance with second embodiment of present invention.

### DETAILED DESCRIPTION OF THE INVENTION

While the preferred embodiments of the invention have been illustrated and described, it will be clear that the invention is not limited to these embodiments only. Numerous modifications, changes, variations, substitutions and equivalents will be apparent to those skilled in the art without parting from the spirit and scope of the present invention.

In an embodiment a multi-color hand-held spraying device is provided. Spraying device includes handle for holding a device, front main nozzle, trigger to control flow of pressurized air, inlet to admit such pressurized air from any external source, such as compressor, aerosol tank and any other source of pressurized air or gas. Handle of the spraying device has rear portion ergonomically curved for comfort of holding the device, trigger for controlling compressed air, inlet air tube, air venting holes, straight front portion coupled with the main air nozzle. Further the device includes a multi-color cartridge. Additionally, multi-color cartridge includes an array of liquid tanks, arranged around horizontal axel of rotation of the cartridge. Moreover, the multi-color cartridge includes a mainframe that attaches itself to the handle and holds array of tanks in predefined position. Multi-color cartridge also includes front sealing ring, rigidly attached to the mainframe of the cartridge and providing sealing means for cartridges, not used for active spraying.

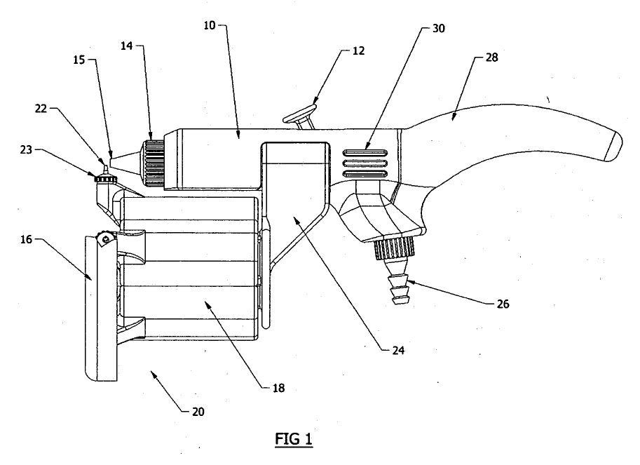

Referring now to the invention in more detail, in FIG. 1 there is shown an airbrush 10 having a handle 28, ergonomically curved for comfortable hold in a user's either right or left hand, main air nozzle 14 with its front tip 15, trigger 12, located approximately in the middle and top portion of handle 28, air venting holes 30, air inlet tube 26 and multi-color cartridge assembly 20.

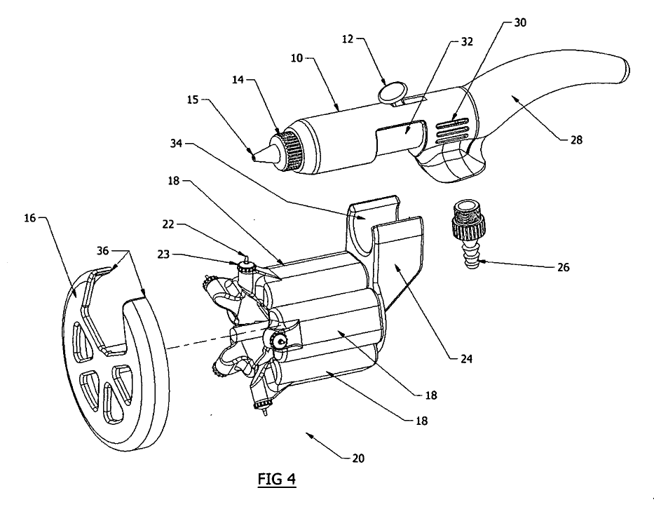

Multi-color cartridge 20 has a mainframe 24 and array of tanks 18, each of which hold liquid and/or colors. Mainframe 24 holds array of tanks 18, has front sealing ring 16 and attaches itself to the underside of the handle 28 using snapping feature 34 as shown in FIG. 4. Each of the tanks 18 has tank nozzle 22 with a ring for manual adjustment 23.

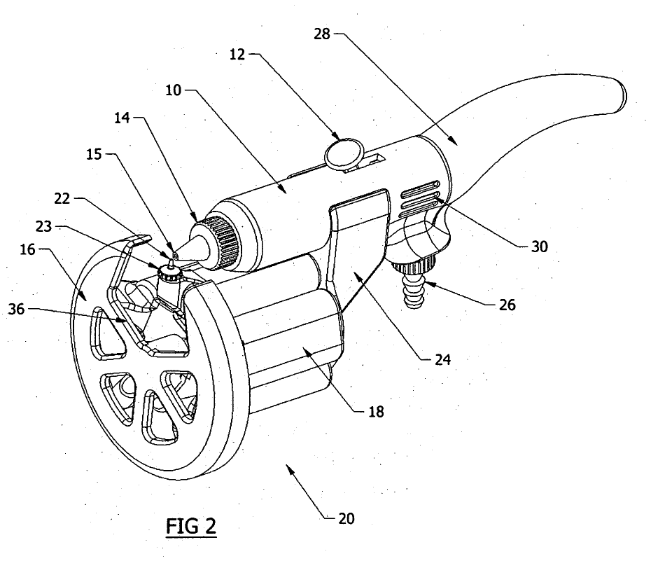

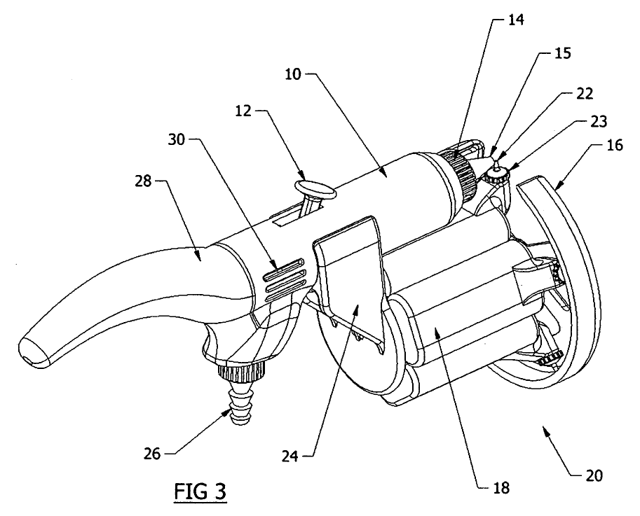

In further detail, still referring to the invention of FIG. 1; FIG. 2; FIG. 3 and FIG. 4, the array of tanks 18 of cartridge 20 can rotate around horizontal axel to provide instant switching between any of the tanks 18 for convenient and un-interrupted spraying of different colors without draining or cleaning tanks 18 or draining and cleaning of main nozzle 14 or tank nozzle 22.

The construction details of the invention are that the airbrush 10 may be made of injection plastic, such as ABS, or of any other sufficiently rigid and strong plastic material such as metal, and the like. Further, the various components of the airbrush 10 can be made also of plastic or metal or other materials.

Cartridge 20 has mainframe with snapping feature 34, which fixedly attaches to the recess 32 on the underside of airbrush handle 28. Mainframe 24 of cartridge assembly 20 stays in fixed position, while array of tanks 18 can rotate around horizontal axel of mainframe 24 with preset angles to provide precise positioning of tank nozzles 22 in front of airbrush nozzle 14 during each rotation.

Referring now to FIG. 4, there is shown exploded view of airbrush 10 having an air inlet tube 26 attaching to the underside of airbrush handle 28. FIG. 4 also shows sealing ring 16, which is attaching to the axel of cartridge mainframe 24 and provides sealing of liquid tanks 18 which are not currently in spraying position. Sealing ring 16 has V-shaped opening 36 in its upper portion, which allows spraying of content of the tank 18, which is positioned in spraying position in front of airbrush nozzle 14.

Airbrush handle 28 has air venting slots 32, which vent pressurized air, when trigger 12 is in forward non-spraying position. As trigger 12 is moved back towards the rear end of airbrush handle 28 pressurized air is redirecting itself and starts coming at high velocity through front tip 15 of airbrush nozzle 14.

In more detail, still referring to the invention of FIG. 1-4, the diameter of front tip 15 of airbrush nozzle 14 is greater than diameter of tank nozzle 22, which creates Venturi Effect during passing of high-velocity air from airbrush nozzle 15 over tank nozzle 22 and thus providing spraying effect.

As shown in FIG. 1, main nozzle 15 has serrations 14 on its base for ease of adjusting position of said nozzle 15 in horizontal direction and in that fashion controlling distance between main nozzle 15 and tank nozzle 22, which allows to control width of spraying angle. Tank nozzle 22 also has serrations 23, allowing to rotate said nozzle 22, and elevate or lower down its position in relation to main nozzle 15, which provides control of spray density.

The construction details of the invention as shown in FIG. 4 are that the multi-color cartridge 20 can be easily and instantly disengaged from airbrush handle 28 and replaced with another multi-color cartridge 20, that contains a set of other liquids or colors. For example cartridge with all neon paints can be instantly replaced with cartridge containing all pastel colors. Or, cartridge with all warm gray-scale colors can be instantly replaced with cartridge holding all cold gray-scale colors.

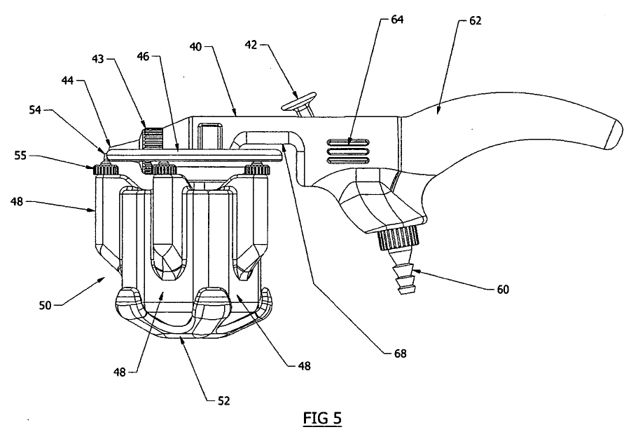

Referring now to FIG. 5, there is shown an airbrush 40 having a multi-color cartridge 50 with array of liquid tanks 48, assembled around vertical axel of cartridge mainframe 52, which attaches itself to the lower portion of airbrush 40.

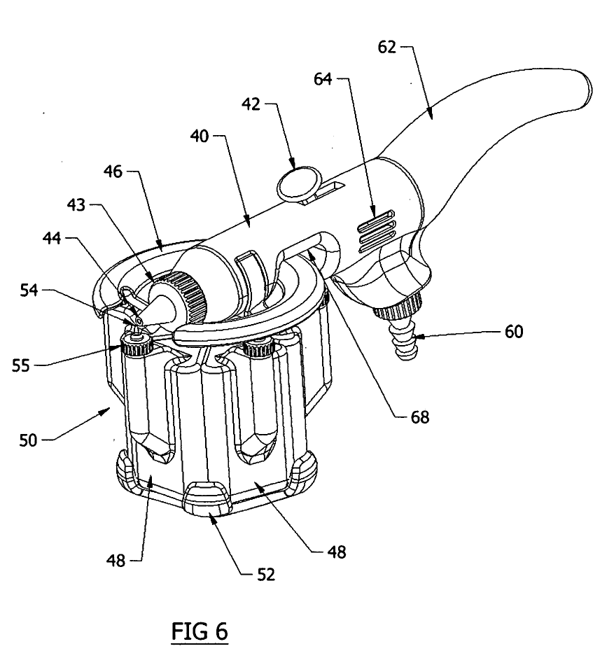

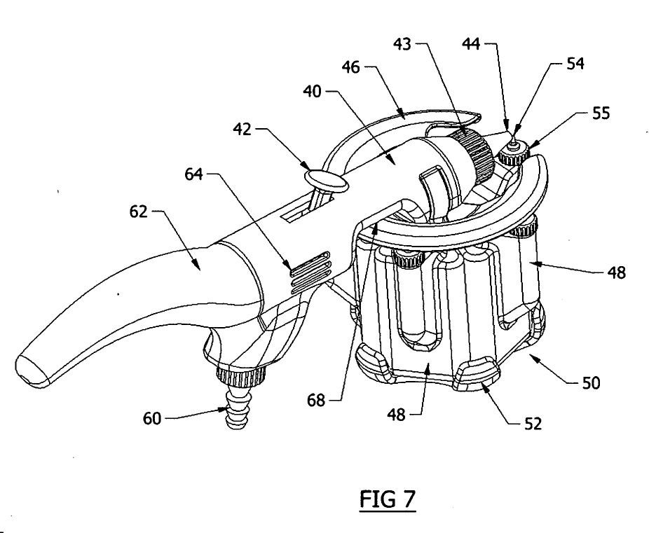

In further detail, referring to the invention of FIG. 5-9, the color cartridge 50 contains a sealing ring 46, which seals nozzles of tanks 48 not in use. Tanks 48 are positioned vertically and rotating around vertical axel of mainframe 52 of cartridge 50, allowing easy access to any of the tanks 48 for immediate spraying without draining or cleaning.

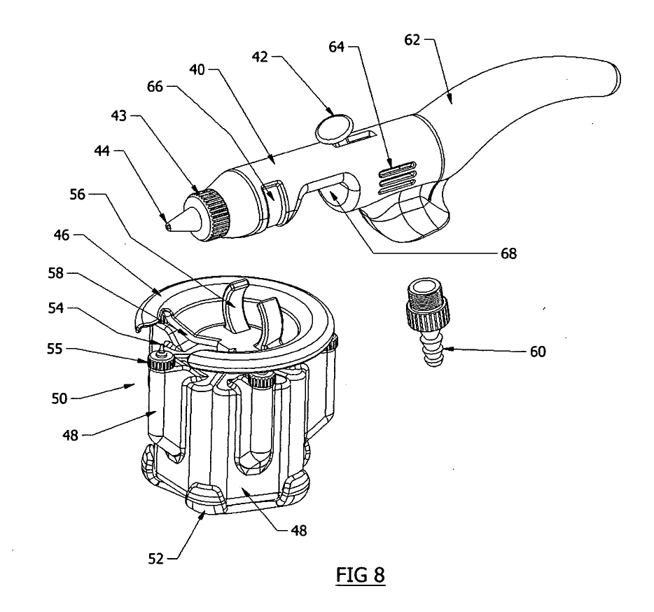

The construction details of the invention as shown in FIG. 8 are that the handle 40 has cutout area on its bottom section to accommodate attaching cartridge 50 using snapping feature 56 and positioning sealing ring 46 in such a way, that V-shaped opening 58 of sealing ring 46 will face forward and provide enough open space for spraying of the content of tank 48, currently positioned in front of airbrush nozzle 44.

Referring now to FIG. 8, there is shown an airbrush 40 with its handle 62, having a recess feature 66, onto which cartridge snaps with its snapping feature 56 into a fixed position.

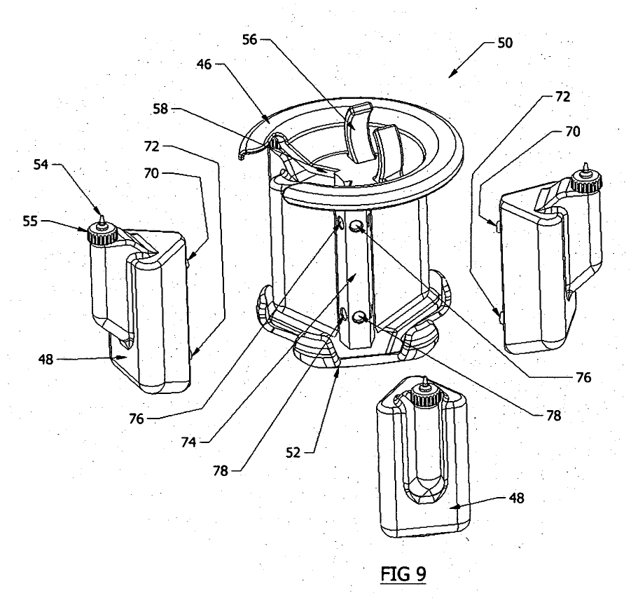

Referring to FIG. 9, there is shown exploded view of the multi-color cartridge 50, having mainframe 52 and top sealing ring 46, array of liquid color tanks 48. Color tanks assemble around stem 74 of the mainframe 52, attaching themselves to the stem 74 radially. Each liquid color tank 48 has protruding upper steel button 70 and protruding lower steel button 72, used for precise positioning of said color tank 48 into assembly of cartridge 50. Stem 74 of the cartridge mainframe 52 has recessed openings 76 in its upper section and similar openings 78 in lower section, which correspond in shape and spacing to steel buttons 70 and 72 on each tank. Liquid color tank 48 can easily be positioned precisely into the cartridge 50 by means of either plastic snaps or by using small round magnets, recessed into openings 76 and 78 on the mainframe stem 74.

Mainframe 52 is constructed in such fashion that its bottom platform, holding tanks 48 can rotate around centerline of stem 74 in incremental angles, providing snapping stop points at such precise angles, so as to position any of the tanks 48 precisely in front of airbrush nozzle 44.

As shown in FIG. 5, main nozzle 44 has serrations 43 on its base for ease of adjusting position of said nozzle 44 in horizontal direction and in that fashion controlling distance between main nozzle 44 and tank nozzle 54, which allows to control width of spraying angle. Tank nozzle 54 also has serrations, allowing to rotate said nozzle, and elevate or lower down its position in relation to main nozzle 44, which provides control of spray density.

The advantages of the present invention include, without limitation, that it provides easy and instant access to multiple colors or types of liquid without need for draining or cleaning the device and its parts. Present invention provides un-interrupted flow of work.

Current invention makes it exceedingly easy to switch between number of colors within one cartridge and/or switch between different cartridges, containing different colors or different types of liquids, including liquids chemically reactive to each other when applied in fast layers.

In broad embodiment, the present invention is an airbrush containing multi-color cartridge with horizontal or vertical axel of tanks rotation.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A multi-color spraying device for spraying liquids having a handle for holding device; air inlet tube to admit compressed air into the device; trigger to control compressed air; threaded spraying air nozzle coupled with the threaded front end of the handle and rotationally having multiple positions for adjusting spraying opening angle; multi-color cartridge rigidly attached to the handle and containing an array of several liquid tanks, wherein said liquid tanks rotate around axel of rotation of the cartridge.

2. The multi-color spraying device of claim 1, wherein the airflow received into the air inlet tube passes through said tube, passes through the control valve inside hollow handle, coupled with the trigger, wherein said trigger controls amount of compressed air admitted to the front air nozzle.

3. The multi-color spraying device of claim 1, wherein threaded front air nozzle is coupled with front end of the handle and receives compressed air, which passes through front air nozzle and out through its front narrow opening, wherein said front air nozzle has radially located serrations on its surface for ease of manual rotation and change nozzle's position in relation to the front end of the handle to adjust spraying opening angle.

4. The multi-color spraying device comprising:
a multi-color cartridge comprising a mainframe having a horizontal axel of rotation as part of said mainframe; an array of liquid tanks radially assembled around said horizontal axel of rotation; a vertical sealing ring rigidly coupled with the mainframe of said cartridge mainframe and sealing openings of the nozzles of liquid tanks; wherein said sealing rind has an opening in predefined location to allow one of the liquid tanks to have tank nozzle exposed and not seal and ready for spraying.

5. The multi-color spraying device of claim 4, wherein each of the liquid tanks in the array has a threaded nozzle, coupled with a thin flexible or rigid tube, extending into the tank to pick up liquid and deliver it to the tank nozzle for spraying, wherein each threaded nozzle of each liquid tank can be rotated and its level position can be adjusted to accommodate the best desired spraying intensity.

6. The multi-color spraying device of claim 4, wherein multi-color cartridge is attached to the handle by means of snapping of designated portion of cartridge mainframe to the handle in predefined and fixed position, wherein handle has recessed area in it for this purpose and cartridge mainframe has fork-shaped snapping feature for this purpose.

7. The multi-color spraying device of claim 4, wherein attached to the handle cartridge provides means for rotating liquid tanks around horizontal axel and bring any of the tanks in spraying ready position, wherein such position is when tank's nozzle comes in close proximity of main spraying nozzle of the handle and air, escaping through said main air nozzle into the open area immediately above tank's nozzle creates zone of low pressure, according to Venturi Effect and pulls liquid from the liquid tank through tanks nozzle and mixes said liquid with air stream, creating spraying mixture.

8. The multi-color spraying device of claim 4, wherein said rotating array of liquid tanks have means of stopping each rotating tank in predefined and precise position, precisely in front of the main air nozzle of the handle.

9. The multi-color spraying device, comprising:
a handle for comfortable holding device in either left or right hand; a trigger for controlling amounts of compressed air admitted for spraying; an air inlet tube to admit compressed air into the device; a main air nozzle, coupled with the front end of the handle; a multi-color cartridge rigidly attached to the handle.

10. The multi-color spraying device of claim 9, wherein multi-color cartridge is holding an array of liquid tanks in vertical position, wherein said multi-color cartridge has a mainframe and a vertical axel of rotation rigidly connected with said mainframe.

11. The multi-color spraying device of claim 9, wherein liquid tanks are radially arranged around vertical axel of rotation and can be rotated around said vertical axel of rotation.

12. The multi-color spraying device of claim 9, wherein said multi-color cartridge has a sealing ring positioned horizontally and above the nozzles of liquid tanks, wherein said sealing ring provides sealing of the opening of the nozzles of liquid tanks.

13. The multi-color spraying device of claim 9, wherein a horizontally positioned sealing ring has an opening, allowing any one of the rotating liquid tanks to expose its nozzle and bring it in close proximity to the main air nozzle of the handle for spraying.

14. The multi-color spraying device of claim 9, wherein an array of vertically arranged liquid tanks can be rotated and has means for any of said liquid tanks for precise and predefined stopping in predefined position in front of the main air nozzle.

15. The multi-color spraying device, comprising a multi-color cartridge with an array of liquid tanks, wherein position of the nozzles of liquid tanks can be leveled with position of the main spraying air nozzle of the handle and said handle may have an opening to allow tanks pass through during rotation.

16. The multi-color spraying device, comprising a multi-color cartridge with an array of liquid tanks, wherein position of the nozzles of liquid tanks is lower than position of the spraying opening of main air nozzle, wherein cartridge has mechanical means of elevating one of the tanks, positioned in front of main air nozzle for spraying and aligning in close proximity nozzle of said active spraying tank with the exit opening of main air nozzle.
